(19) United States
(12) Patent Application Publication
(10) Pub. No.: US 2025/0214659 A1
(43) Pub. Date: Jul. 3, 2025

(54) VEHICLE LOWER STRUCTURE

(71) Applicant: TOYOTA JIDOSHA KABUSHIKI KAISHA, Toyota-shi (JP)

(72) Inventor: Takuya IWATA, Gotemba-shi (JP)

(73) Assignee: TOYOTA JIDOSHA KABUSHIKI KAISHA, Toyota-shi (JP)

(21) Appl. No.: 18/980,167

(22) Filed: Dec. 13, 2024

(30) Foreign Application Priority Data
Dec. 28, 2023 (JP) 2023-222136

(51) Int. Cl. B62D 37/02; B62D 35/02

(52) U.S. Cl. CPC B62D 37/02; B62D 35/02

(57) ABSTRACT

The vehicle lower structure includes a plurality of rectifying members disposed on the lower surface of the vehicle body behind the rear tire. Each of the plurality of rectifying members has a flat plate shape, and protrudes downward from the lower surface of the vehicle body and extends in the vehicle front-rear direction. The plurality of rectifying members is arranged at intervals in the vehicle width direction.

### CROSS-REFERENCE TO RELATED APPLICATION

This application claims priority to Japanese Patent Application No. 2023-222136 filed on Dec. 28, 2023, incorporated herein by reference in its entirety.

### BACKGROUND

### 1. Technical Field

The present disclosure relates to vehicle lower structures, and more particularly, to a vehicle lower structure that improves steering stability of a vehicle.

### 2. Description of Related Art

A technique for vehicles such as motor vehicles is known in which fins are provided on combination lamps at the rear of a vehicle, side mirrors located at the front of a vehicle, etc. to improve steering stability of the vehicle.

Japanese Unexamined Patent Application Publication No. 2020-29128 (JP 2020-29128 A) discloses a structure in which fins are provided on side visors in order to improve steering stability of a vehicle.

### SUMMARY

When fins are provided at a position on a vehicle that is easily visible to the user, the fins may affect the vehicle design. A technique is desired that improves steering stability of a vehicle while reducing the influence on the vehicle design.

An object of the present disclosure is to improve steering stability of a vehicle while reducing an influence on the vehicle design.

A vehicle lower structure according to an aspect of the present disclosure includes
a plurality of rectifying members disposed on a lower surface of a vehicle body behind a rear tire.
Each of the rectifying members has a flat plate shape, protrudes downward from the lower surface of the vehicle body, and extends in a vehicle front-rear direction.
The rectifying members are spaced apart from each other in a vehicle width direction.

In the vehicle lower structure of the above aspect,
the rectifying members may be composed of a first rectifying member and a second rectifying member,
the first rectifying member may be disposed inward of a middle in a width direction of the rear tire in the vehicle width direction, and
the second rectifying member may be disposed outward of the first rectifying member in the vehicle width direction.

In the vehicle lower structure of the above aspect,
the second rectifying member may be disposed outward of the middle in the width direction of the rear tire in the vehicle width direction.

In the vehicle lower structure of the above aspect,
the first rectifying member may have a greater length in the vehicle front-rear direction than the second rectifying member.

In the vehicle lower structure of the above aspect,
each of the rectifying members may include a front portion including a tilted surface tilted downward from vehicle front toward vehicle rear, and a rear portion including a tilted surface tilted upward from the vehicle front toward the vehicle rear, and
in each of the rectifying members, the tilted surface of the front portion may be steeper than the tilted surface of the rear portion.

According to the present disclosure, when the vehicle is traveling, wind from the outer side in the width direction of the rear tire and wind from the inner side in the width direction of the rear tire are rectified by the rectifying members disposed behind the rear tire. Steering stability of the vehicle can thus be improved. Since the rectifying members are disposed on the lower surface of the vehicle body that is less visible from the user, the influence of the rectifying members on the vehicle design can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a rear portion of a vehicle;

FIG. 2 is a side view of a group of rectifying members of a vehicle;

FIG. 3 is a perspective view of the rear bottom of the vehicle;

FIG. 4 is a perspective view of a group of rectifying members of a vehicle;

FIG. 5 is a bottom view of a group of rectifying members of a vehicle; and

FIG. 6 is a radar chart illustrating the effect of the rectifying member group.

### DETAILED DESCRIPTION OF EMBODIMENTS

Hereinafter, embodiments of the present disclosure will be described with reference to the drawings. The present disclosure is not limited to the embodiment described below. In all the drawings, the same elements are denoted by the same reference numerals, and redundant description is omitted. In the following description, unless otherwise specified, the terms indicating the front-rear, right-left, and up-down, etc. directions indicate the directions related to a vehicle. In the drawings, the direction of the arrow FR indicates the front side, the direction of the arrow UP indicates the upper side, and the direction of the arrow RH indicates the right side. In addition, a side close to the center of the vehicle in the left-right direction (width direction) is referred to as an inner side in the vehicle width direction, and a side far from the center is referred to as an outer side in the vehicle width direction.

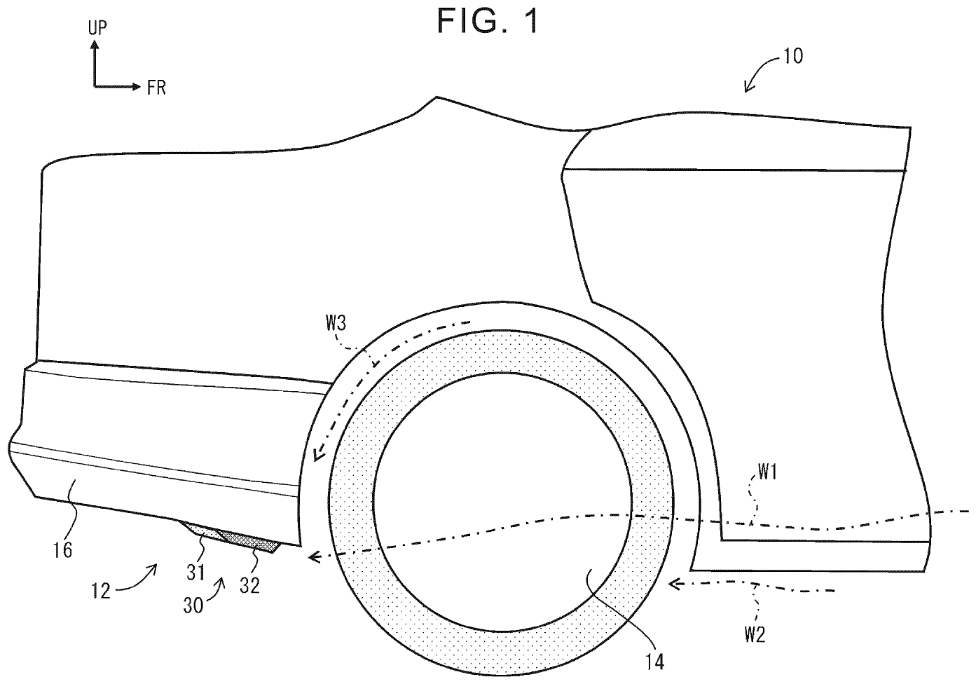

FIG. 1 is a side view of a rear portion of a vehicle 10, showing a right side surface of the vehicle 10. The vehicle 10 is an automobile. The vehicle 10 comprises two front tires (not shown) and two rear tires 14 (only one is shown in FIG. 1).

The vehicle 10 may be a vehicle having a relatively high vehicle height and a relatively high center of gravity position, such as a vehicle or a wagon Sport Utility Vehicle (SUV). Such vehicles are generally disadvantageous in terms of steering stability. However, by adopting the vehicle lower structure 12 described below, the steering stability can be improved. The vehicle lower structure 12 may also be employed in other vehicles, such as sedan vehicles, thereby improving the steering stability of those vehicles.

As shown in FIG. 1, the vehicle lower structure 12 includes a rectifying member group 30 disposed on the lower surface of the vehicle body behind the rear tire 14. The rectifying member group 30 includes a first rectifying member 31 and a second rectifying member 32. FIG. 1 shows a first rectifying member 31 and a second rectifying member 32 which appear on the underside of the rear bumper 16. In the following description, the rectifying member group 30 disposed behind the right rear tire 14 is described, but the same rectifying member group 30 is disposed behind the left rear tire (not shown). That is, the vehicle 10 includes a pair of rectifying member groups 30 symmetrically.

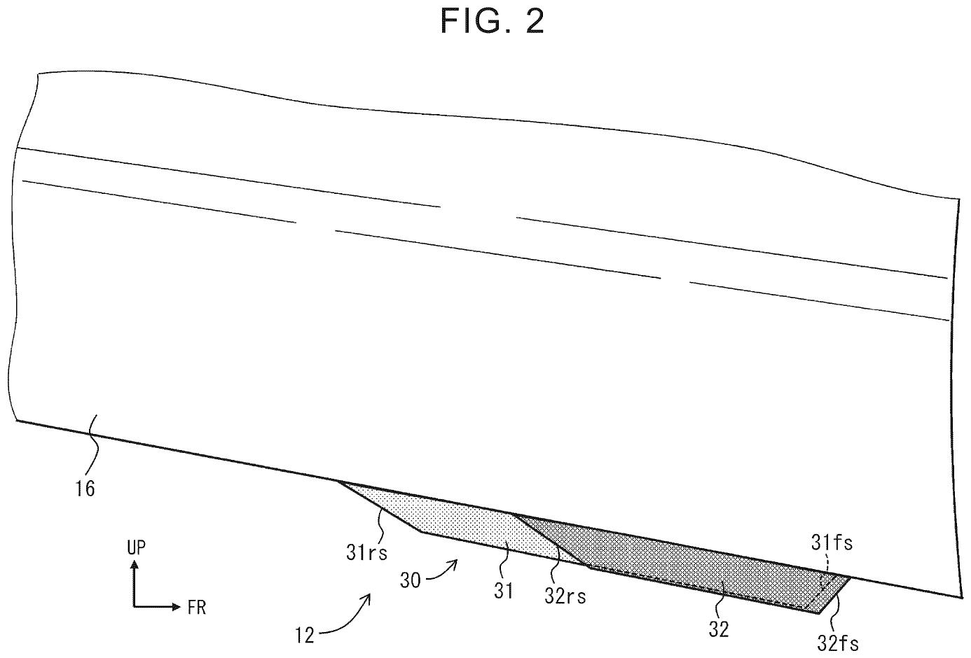

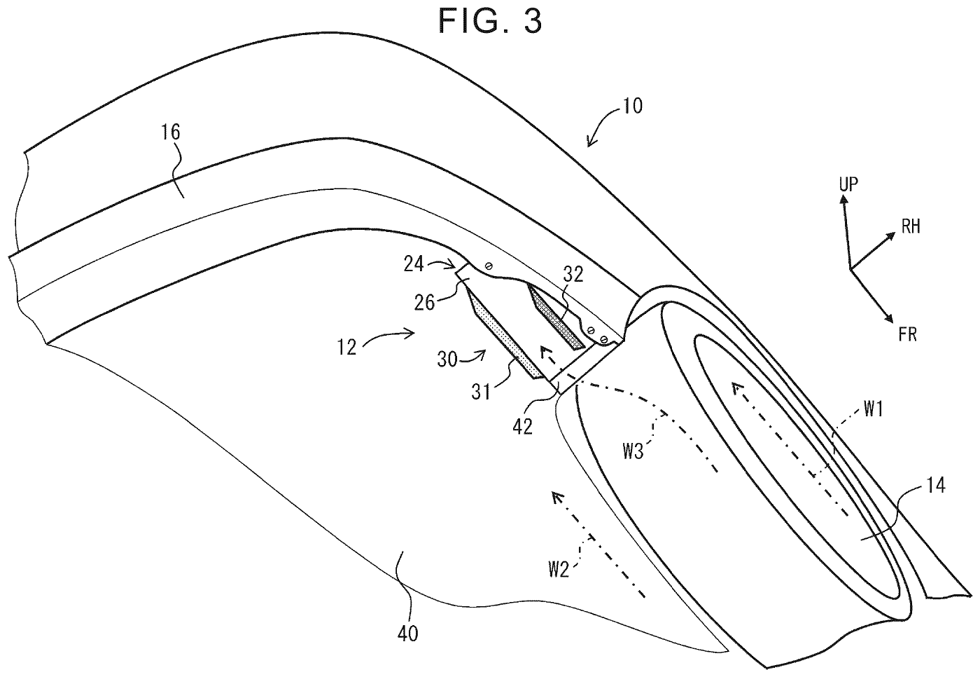

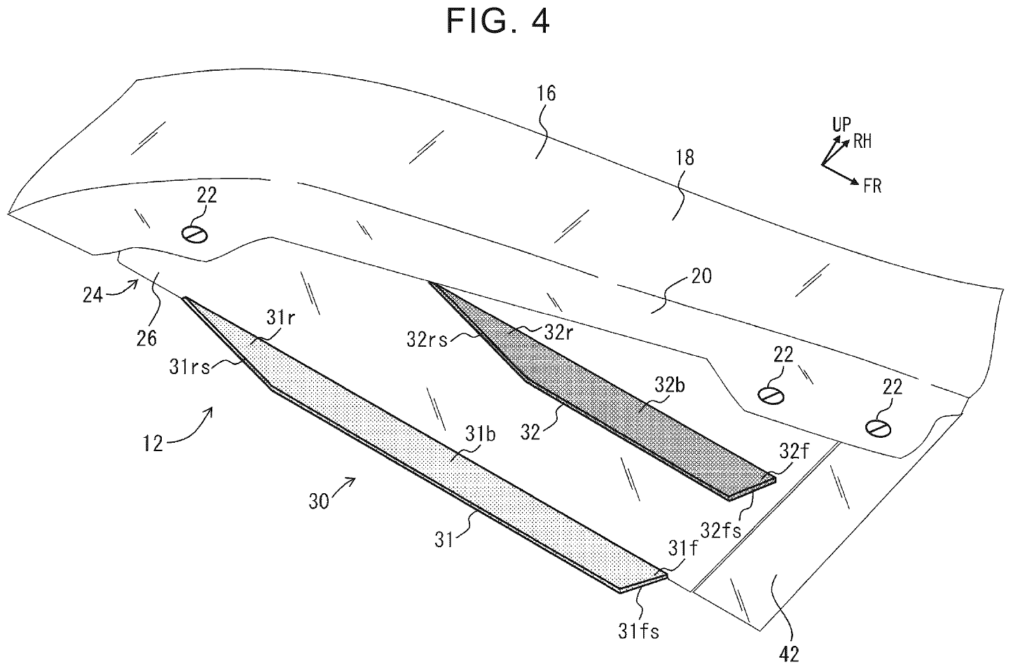

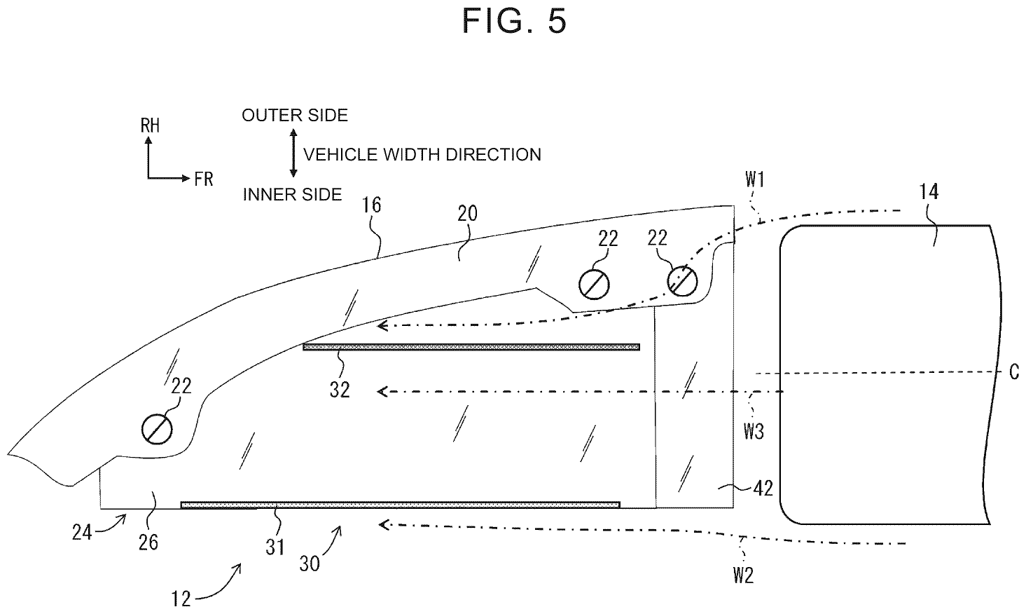

FIG. 2 is an enlarged view of a portion of the rectifying member group 30 of FIG. 1. In FIG. 2, the outline of a part of the first rectifying member 31 on the back side of the second rectifying member 32 is indicated by a dotted line. FIG. 3 is a perspective view of the rear bottom 40 of the vehicle 10. FIG. 4 is a perspective view of the rectifying member group 30 of the vehicle 10. FIG. 5 is a bottom view of the rectifying member group 30 of the vehicle 10.

As shown in FIG. 3, the vehicle 10 includes a wheel house panel 42, a rear bumper 16, and a bottom member 24. The wheel house panel 42 forms a wheel house of the rear tire 14. As shown in FIG. 4, the rear bumper 16 includes a side portion 18 and an edge portion 20. The edge portion 20 is a portion bent downward from the side portion 18 of the rear bumper 16. Note that, although the rear bumper 16 actually has a stepped shape change, that is, a gentle curved surface, between the side portion 18 and the edge portion 20, the curved surface is omitted in FIGS. 3 to 5, and the shape of the rear bumper 16 is simplified.

The bottom member 24 is, for example, a resin component manufactured by injection molding. As shown in FIG. 3, the bottom member 24 includes a base plate 26 and a rectifying member group 30. The bottom member 24 further includes an upper portion (not shown) connected to the base plate 26 disposed on the upper side (vehicle body inner side) of the base plate 26, and the upper portion thereof is fixed to a structure (not shown) provided in the vehicle rear portion. As shown in FIG. 3, the base plate 26 forms a part of the bottom surface of the vehicle body. The base plate 26 is disposed behind the wheel house panel 42.

As shown in FIG. 4, the base plate 26 of the bottom member 24 is disposed above the edge portion 20 of the rear bumper 16. A portion of the base plate 26 on the outer side in the vehicle width direction is fixed to the edge portion 20 of the rear bumper 16 by a screw 22.

As shown in FIG. 4, the first rectifying member 31 and the second rectifying member 32 are arranged in parallel at intervals in the vehicle width direction. The first and second rectifying members 31, 32 project downward from the base plate 26. The first and second rectifying members 31, 32 extend in the front-rear direction. That is, the directions in which the first and second rectifying members 31, 32 extend coincide with the front-rear direction of the vehicle. The first and second rectifying members 31, 32 each have a flat plate shape. The thicknesses (widths in the vehicle width direction) of the first and second rectifying members 31, 32 are constant or substantially constant in the front-rear direction.

The first rectifying member 31 includes a front portion 31f, a body portion 31b, and a rear portion 31r. The front portion 31f has a tilted surface 31fs (see FIG. 2) that is tilted downward from front toward rear. The body portion 31b has a constant or substantially constant height. The rear portion 31r has a tilted surface 31rs tilted upward from front toward rear.

Similarly, the second rectifying member 32 includes a front portion 32f, a body portion 32b, and a rear portion 32r. The front portion 32f has a tilted surface 32fs (see FIG. 2) that is tilted downward from front toward rear. The body portion 32b has a constant or substantially constant height. The rear portion 32r has a tilted surface 32rs tilted upward from front toward rear.

In each of the first and second rectifying members 31, 32, the tilted surface 31fs (32fs) of the front portion 31f (32f) is steeper than the tilted surface 31rs (32rs) of the rear portion 31r (32r). The tilted surface 31fs (32fs) of the front portion 31f (32f) is relatively steep in order to catch the wind faster during traveling of the vehicle and to flow the wind along the body portion 31b (32b). The tilted surface 31rs (32rs) of the rear portion 31r (32r) is relatively gentle in order to allow the wind having flowed along the body portion 31b (32b) to smoothly flow backward and from the standpoint of appearance.

As shown in FIG. 2, the front end of the second rectifying member 32 is located slightly forward of the front end of the first rectifying member 31. Further, in this embodiment, as shown in FIG. 2, the height of the body portion of the second rectifying member 32 is slightly higher than the height of the body portion of the first rectifying member 31. The height of the body portion of the first rectifying member 31 and the height of the body portion of the second rectifying member 32 may be the same.

Further, in this embodiment, as shown in FIG. 5, the first rectifying member 31 is longer in length in the front-rear direction than the second rectifying member 32. This difference in length relies on the limitations of the placement space. That is, as shown in FIG. 5, since the rear bumper 16 (the vehicle body side portion) is slightly curved from the outside toward the inside in the vehicle width direction, the length of the second rectifying member 32 in the front-rear direction is limited as compared with the length of the first rectifying member 31. In the case where there is no such restriction, for example, in a case where the vehicle body shape behind the rear tire 14 can allow the extension of the length of the second rectifying member 32, the length of the second rectifying member 32 in the front-rear direction may be the same as or substantially the same as the length of the first rectifying member 31 in the front-rear direction.

As shown in FIG. 5, the first rectifying member 31 is inward of the middle C in the width direction of the rear tire 14 in the vehicle width direction. The second rectifying member 32 is disposed outward of the first rectifying member 31 in the vehicle width direction. Specifically, the second rectifying member 32 is disposed slightly outward of the middle C in the width direction of the rear tire 14 in the vehicle width direction. Further, the distance between the first rectifying member 31 and the second rectifying member 32 is narrower than the width of the rear tire 14.

Next, the operation and effect of the vehicle lower structure 12 in which the first and second rectifying members 31, 32 are provided in the above embodiment, that is, behind the right and left rear tires 14, respectively, will be described.

When the vehicle 10 travels forward, as shown in FIG. 5, winds W1 to W3 are generated behind the rear tire 14. The wind W1 is a wind that flows through the vehicle-side surface, flows on the widthwise outer side of the rear tire 14, and is caught behind the rear tire 14. The wind W2 is a wind that flows through the bottom surface of the vehicle body, flows in the widthwise inner side of the rear tire 14, and enters behind the rear tire 14. The wind W3 is a wind flowing through the wheel house of the rear tire 14 to behind the rear tire 14.

The winds W1 to W3 have different flow rates. In particular, the winds W1, W2 have different flow rates. When these winds mix, i.e., intersect, behind the rear tire 14, turbulence of the winds occurs and the stability of the vehicle 10 deteriorates.

However, according to the embodiment described above, the winds W1 to W3 can be divided by the first and second rectifying members 31, 32, and the crossing of these winds can be reduced. That is, as shown in FIG. 5, a large amount of the wind W1 can flow on the outer side (outer side in the vehicle width direction) of the second rectifying member 32. The second rectifying member 32 suppresses the wind W1 from entering the inner side in the vehicle width direction behind the rear tire 14. That is, the second rectifying member 32 blocks the wind W1 from entering the inside in the vehicle widthwise direction. Further, as shown in FIG. 5, a large amount of the wind W2 can flow on the outer side (inner side in the vehicle width direction) of the first rectifying member 31. The first rectifying member 31 suppresses the wind W2 from advancing outward in the vehicle width direction behind the rear tire 14. That is, the first rectifying member 31 blocks the wind W2 from traveling outward in the vehicle widthwise direction. Also, much of the wind W3 can flow between the first and second rectifying members 31, 32. As described above, by rectifying the flow of the wind by the first and second rectifying members 31 and 32, the steering stability of the vehicle 10 can be improved.

According to the embodiment described above, it is possible to ensure stable straight traveling performance during vehicle traveling. Further, even when the steering wheel is turned off (during steering) while the vehicle is running, the turbulence of the wind is reduced, so that the vehicle can turn stably.

Further, according to the embodiment described above, since the first and second rectifying members 31, 32 are arranged on the lower surface of the vehicle body that is difficult to be seen by the user, the influence of the first and second rectifying members 31, 32 on the design of the vehicle 10 can be suppressed. It is possible to achieve both of the steering stability and the design of the vehicle 10.

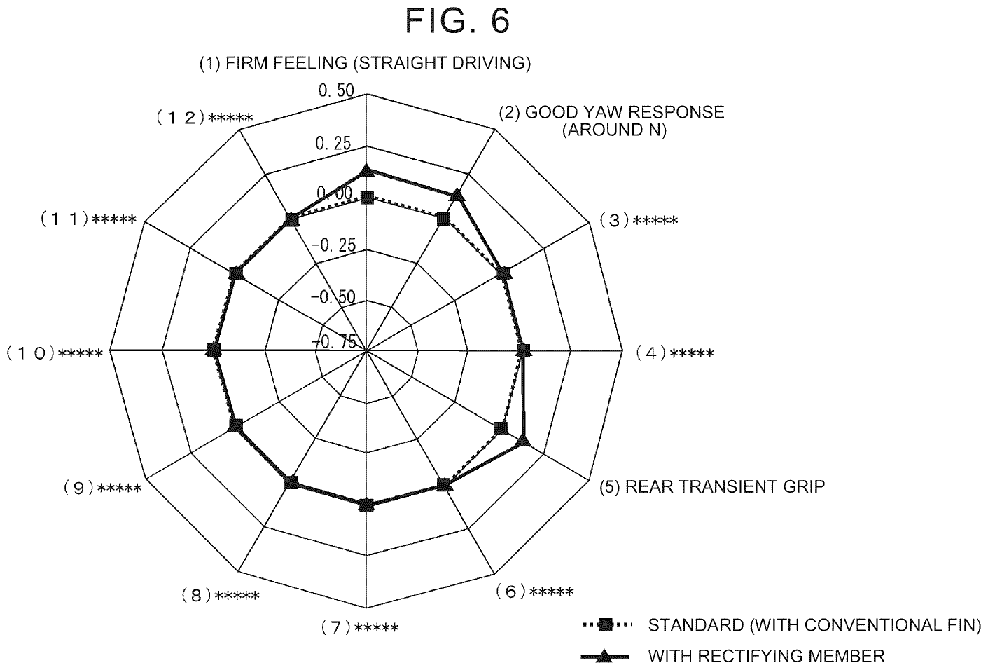

FIG. 6 is a radar chart showing the effect of the vehicle lower structure 12 (with a rectifying member) described above. A plurality of drivers drove a vehicle (hereinafter referred to as a conventional vehicle) in which fins are provided in conventional rear combination lamps (combination lamps at the rear of the vehicle) and a vehicle 10 (hereinafter referred to as the present vehicle) that uses the vehicle lower structure 12 of the present embodiment, and evaluated 12 items related to steering stability. Naturally, the conventional vehicle is not provided with the rectifying member described above, and the present vehicle is not provided with the fins of the conventional rear combination lamps. Then, for each item, a representative value in which evaluation results of a plurality of drivers appear is obtained and plotted on a radar chart. Thus, FIG. 6 shows an evaluation result of the present vehicle (with a rectifying member) based on the conventional vehicle.

As shown in FIG. 6, it was confirmed that, according to the vehicle 10 provided with the present vehicle, that is, the first and second rectifying members 31, 32, the steering stability equal to or higher than the standard (conventional vehicle) can be ensured. In particular, by providing the first and second rectifying members 31, 32 as compared with the reference (fins of the rear combination lamps), it was confirmed that the “feeling of tightness (when traveling straight)”, the “good yaw response (around N)”, and the “feeling of rear transient grip” were improved.

It should be noted that the “feeling of tightness (when traveling straight)” is stability when the vehicle travels straight, and is less likely to be swung to the left and right when the vehicle is traveling straight. Further, the “good yaw response (near N)” is the responsiveness at the start of turning the steering wheel when the vehicle is running, and is the good response of the vehicle when the steering wheel is turned straight (N) and the steering wheel is slightly turned off. Further, the “rear transient grip feeling” is a grip feeling of the rear portion of the vehicle when the vehicle is steeply changed in lane while the vehicle is traveling, and is a feeling that the rear tire is touched and stable when the vehicle is steeply changed in lane.

From the above, it can be understood that the vehicle lower structure 12 of the present embodiment has an excellent structure from the viewpoint of steering stability.

In the embodiment described above, the rectifying member group 30 is constituted by two rectifying members (first and second rectifying members 31, 32). However, the rectifying member group 30 may include three or more rectifying members.

What is claimed is:

1. A vehicle lower structure comprising a plurality of rectifying members disposed on a lower surface of a vehicle body behind a rear tire, wherein:
each of the rectifying members has a flat plate shape, protrudes downward from the lower surface of the vehicle body, and extends in a vehicle front-rear direction; and
the rectifying members are spaced apart from each other in a vehicle width direction.

2. The vehicle lower structure according to claim 1, wherein:
the rectifying members are composed of a first rectifying member and a second rectifying member;
the first rectifying member is disposed inward of a middle in a width direction of the rear tire in the vehicle width direction; and
the second rectifying member is disposed outward of the first rectifying member in the vehicle width direction.

3. The vehicle lower structure according to claim 2, wherein the second rectifying member is disposed outward of the middle in the width direction of the rear tire in the vehicle width direction.

4. The vehicle lower structure according to claim 2, wherein the first rectifying member has a greater length in the vehicle front-rear direction than the second rectifying member.

5. The vehicle lower structure according to claim 1, wherein:
each of the rectifying members includes a front portion including a tilted surface tilted downward from vehicle front toward vehicle rear, and a rear portion including a tilted surface tilted upward from the vehicle front toward the vehicle rear; and
in each of the rectifying members, the tilted surface of the front portion is steeper than the tilted surface of the rear portion.
